(19) United States
(12) Patent Application Publication
(10) Pub. No.: US 2026/0142114 A1
(43) Pub. Date: May 21, 2026

(54) FUSE MODULE

(71) Applicant: Littelfuse, Inc., Rosemont, IL (US)

(72) Inventors: Jonathan Hernandez, Chicago, IL (US); Michael Schlaak, Mount Prospect, IL (US); Gary Bold, Palatine, IL (US); Davide Maini, Lardirago (IT); Matthew Yurkanin, Mount Prospect, IL (US)

(73) Assignee: Littelfuse, Inc., Rosemont, IL (US)

(21) Appl. No.: 19/389,270

(22) Filed: Nov. 14, 2025

Related U.S. Application Data
(60) Provisional application No. 63/720,974, filed on Nov. 15, 2024.

(51) Int. Cl. H01H 85/175; H01H 69/02; H01H 85/055; H01H 85/20

(52) U.S. Cl. CPC H01H 85/1755; H01H 69/02; H01H 85/055; H01H 85/2005; H01H 2231/026; H01H 2239/034

(57) ABSTRACT

A mechanically strong, robust, and flexibly designed fuse module is provided that can include (1) a fusible element surrounded by two housings and (2) mechanically reinforced terminals. In particular, the fusible element can be disposed between a first terminal and a second terminal, an inner housing can surround the fusible element, and an outer housing can be overmolded over the inner housing such that the first terminal and the second terminal can extend outside of both the inner housing and the outer housing. The first terminal can be mechanically reinforced by bending so as to fold around and onto the outer housing, and the second terminal can be double layered for mechanical reinforcement.

### CROSS-REFERENCE TO RELATED APPLICATIONS

The present application claims the benefit of priority under 35 U.S.C. § 119 to U.S. Provisional Application Ser. No. 63/720,974, entitled “FUSE MODULE” and filed Nov. 15, 2024, the disclosure of which is incorporated herein by reference in its entirety.

### FIELD

The present disclosure generally relates to circuit protection devices. More particularly, the present disclosure relates to a low-profile integrated fuse module suitable for automotive battery applications.

### BACKGROUND

Fuse modules can be implemented in automotive applications. In a typical implementation, a fuse module is mounted to a source of electrical power (e.g., a battery) and is electrically connected in series between the source and a connected load. Upon an occurrence of an overcurrent condition, a fusible element within the fuse module melts, disintegrates, or otherwise opens to arrest current flow through the fuse module. The fuse module thereby prevents or mitigates electrical damage to the source and/or the connected load that would otherwise result if the overcurrent condition were allowed to persist.

In some applications, it is imperative that the fuse module be mechanically strong and robust so as to protect the fuse module and an environment in which the fuse module is located and so as to withstand pressures and weights applied thereto. It is also imperative that the fuse module have flexibility in design so as to be suitable for different applications and environments. Accordingly, there is a continuing, ongoing need for improved fuse modules.

### BRIEF SUMMARY

This Brief Summary is provided to introduce a selection of concepts in a simplified form that are further described below in the Detailed Description. This Brief Summary is not intended to identify key features or essential features of claimed subject matter or intended as an aid in determining scope of the claimed subject matter.

In some embodiments, a fuse module can include a fusible element disposed between a first terminal and a second terminal, a first housing surrounding the fusible element, and a second housing overmolded over the first housing. The first terminal can extend outside of the first housing and the second housing and be mechanically reinforced, and the second terminal can extend outside of the first housing and the second housing and be mechanically reinforced.

In some embodiments, the first housing can include a top portion and a bottom portion that can be mechanically fit together.

In some embodiments, the first housing can include an inner volume, and the fusible element can be disposed within the inner volume.

In some embodiments, the first housing can include at least one venting channel.

In some embodiments, an exterior of the second housing can include one or more side features for securing the second housing to a fuse box.

In some embodiments, the second terminal can bend 180° to overlap on itself and create first and second layers of the second terminal.

In some embodiments, the first and second layers can include holes for receiving a mechanical fastener to lock the first and second layers together.

In some embodiments, the second housing can be overmolded over the holes and the mechanical fastener.

In some embodiments, the second terminal can include a first layer contiguous with the fusible element and a second layer attached to the first layer.

In some embodiments, the second housing can be overmolded over at least part of a connection between the first layer and the second layer.

In some embodiments, the second housing can include one or more openings formed by one or more mold inserts that can hold the first housing during an overmolding process to form the second housing, and a portion of the first housing held by the one or more mold inserts during the overmolding process can remain exposed after the overmolding process.

In some embodiments, a method of manufacturing a fuse module can include mechanically securing a first housing around a fusible element disposed between a first terminal and a second terminal and overmolding a second housing over the first housing. The first terminal can extend outside of the first housing and the second housing and be mechanically reinforced, and the second terminal can extend outside of the first housing and the second housing and be mechanically reinforced.

In some embodiments, the method can include further ultrasonic welding, snap fitting, heat staking, or press fitting a top portion and a bottom portion of the first housing together.

In some embodiments, the first housing can include an inner volume and at least one venting channel, and the fusible element can be disposed within the inner volume.

In some embodiments, the method can include overmolding the second housing with one or more side features for securing the second housing to a fuse box.

In some embodiments, the method can include bending the second terminal 180° to overlap on itself and create first and second layers of the second terminal.

In some embodiments, the method can include overmolding the second housing over holes disposed in the first and second layers and a mechanical fastener disposed therein to lock the first and second layers together.

In some embodiments, the method can include attaching a second layer of the second terminal to a first layer of the second terminal that is contiguous with the fusible element and overmolding the second housing over at least part of a connection between the first layer and the second layer.

In some embodiments, the method can include holding the first housing with one or more mold inserts during an overmolding process to form the second housing.

In some embodiments, the second housing can include one or more openings formed by the one or more mold inserts, and a portion of the first housing held by the one or more mold inserts during the overmolding process can remain exposed after the overmolding process.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an exploded view illustrating a fuse module in accordance with disclosed embodiments.

FIG. 2 is an exploded view illustrating a portion of a fuse module in accordance with disclosed embodiments.

FIG. 3A is a perspective view illustrating a fuse module in accordance with disclosed embodiments.

FIG. 3B is a perspective view illustrating a fuse module in accordance with disclosed embodiments.

FIG. 4A is a perspective view illustrating a fuse module in accordance with disclosed embodiments.

FIG. 4B is a perspective view illustrating a fuse module in accordance with disclosed embodiments.

FIG. 4C is a ghosted view illustrating a fuse module in accordance with disclosed embodiments.

FIG. 5A is a top or a bottom view illustrating a fuse module in accordance with disclosed embodiments.

FIG. 5B is a side view illustrating a fuse module in accordance with disclosed embodiments.

FIG. 6 is a flow chart illustrating a method of manufacturing a fuse module in accordance with disclosed embodiments.

### DETAILED DESCRIPTION

Exemplary embodiments of a fuse module in accordance with the present disclosure will now be described more fully hereinafter with reference made to the accompanying drawings. The fuse module may, however, be embodied in many different forms and should not be construed as being limited to the embodiments set forth herein. Rather, these embodiments are provided so that this disclosure will convey certain exemplary aspects of the fuse module to those skilled in the art.

In accordance with disclosed embodiments, the fuse module can have a low profile, thereby occupying minimal space, and in some embodiments, the fuse module can provide time-delay circuit protection. In some embodiments, the fuse module can be free hanging, and in some embodiments, the fuse module can be secured within a fuse box.

The fuse module disclosed herein can have a voltage rating as needed for an application in which the fuse module is used. In particular, in some embodiments, the voltage rating can be 32V or 70V. Similarly, the fuse module can have an amperage rating as needed for the application in which the fuse module is used. In particular, in some embodiments, the amperage rating can be 100-600 A.

In some embodiments, the fuse module can include a reverse polarity fuse, and in some embodiments, the fuse module can be used in automotive applications. However, embodiments disclosed herein are not limited in this regard.

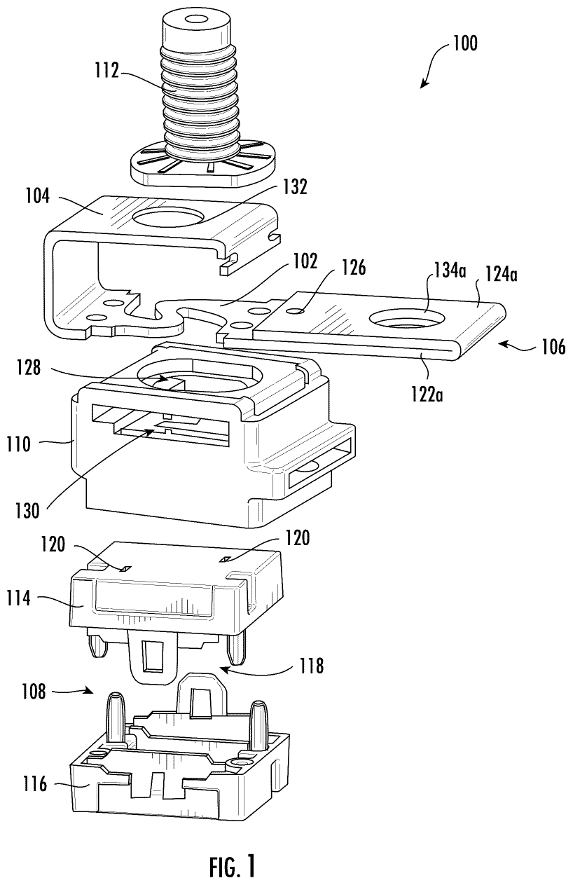

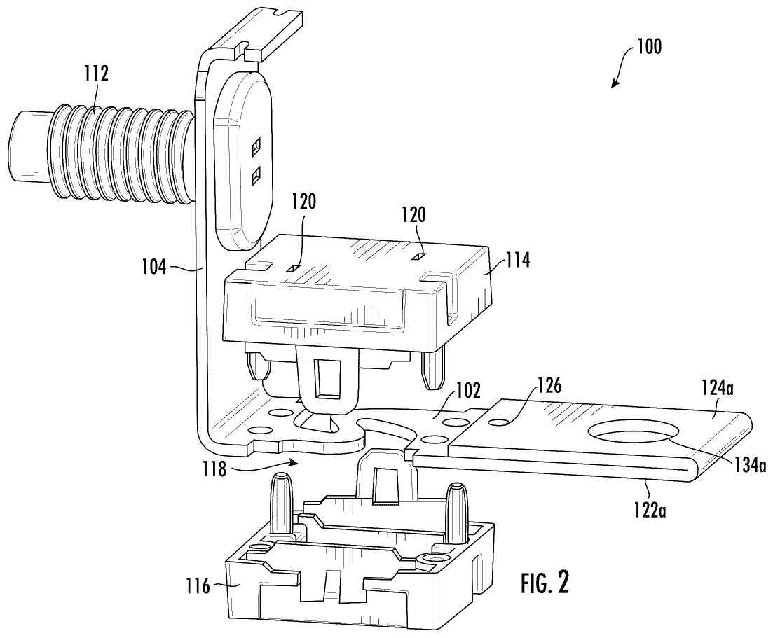

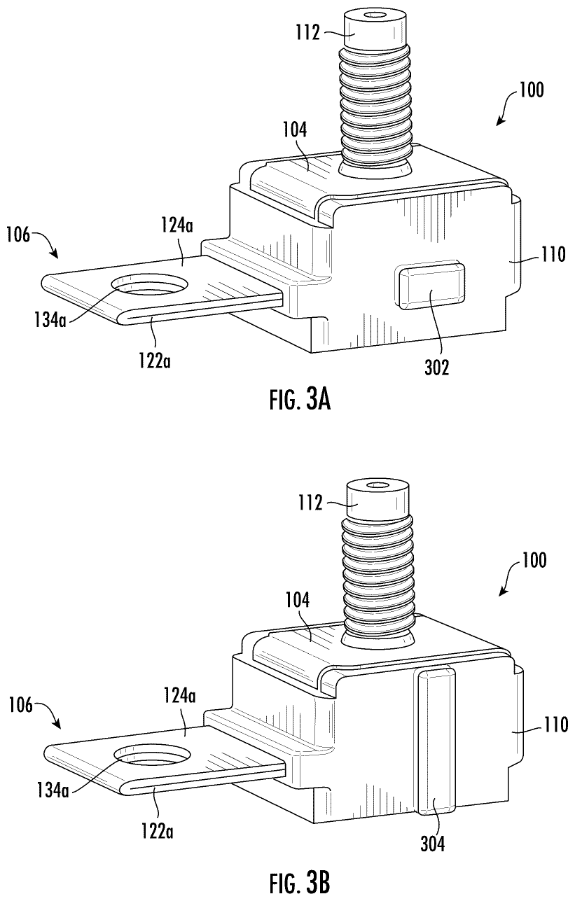

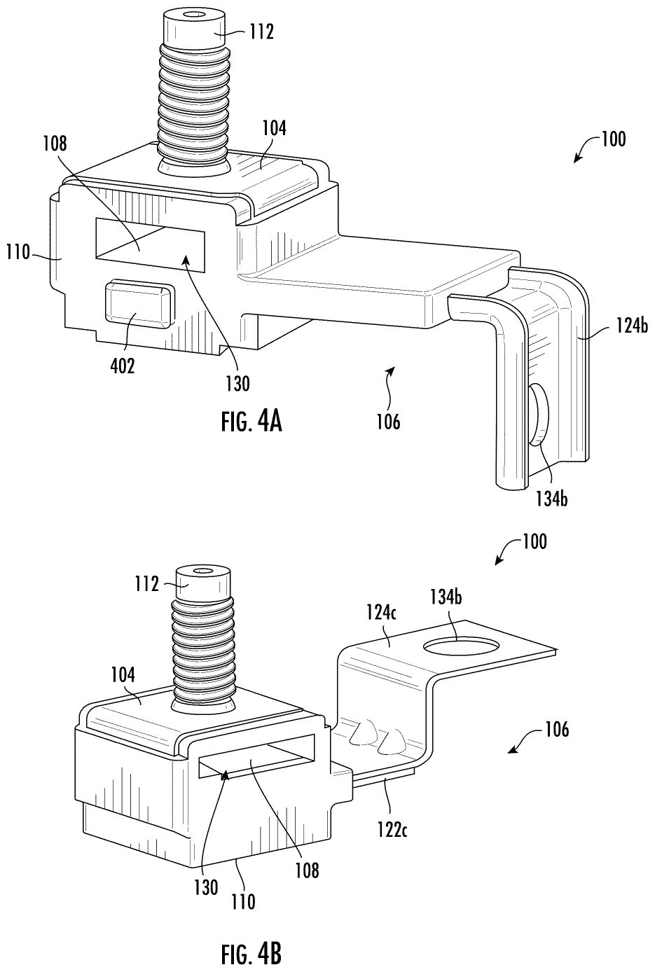

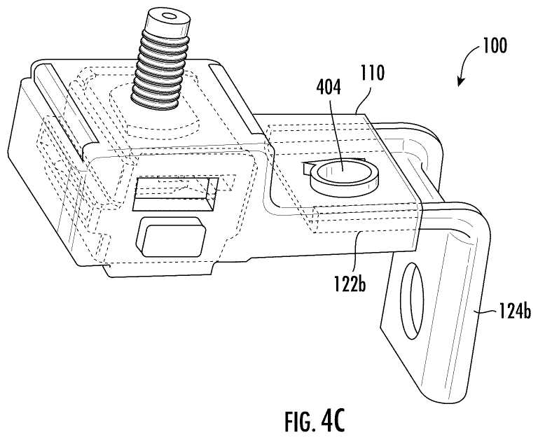

In accordance with disclosed embodiments, the fuse module can include a fusible element surrounded by two housings so as to be mechanically strong and robust, thereby protecting the fuse module and an environment in which the fuse module is located while also withstanding pressures and weights applied thereto. In this regard, FIG. 1 and FIG. 2 are exploded views illustrating a fuse module 100 in accordance with disclosed embodiments. FIG. 3A and FIG. 3B are perspective views illustrating the fuse module 100 fully assembled, and FIG. 4A and FIG. 4B are perspective views illustrating the fuse module 100 fully assembled with alternative terminals.

As seen in FIG. 1 and FIG. 2, in particular, the fuse module 100 can include a fusible element 102 disposed between a first terminal 104 and a second terminal 106, a first housing 108—an inner housing—surrounding the fusible element 102, and a second housing 110—an outer housing—overmolded over the first housing 108. Both of the first terminal 104 and the second terminal 106 can extend outside of the first housing 108 and the second housing 110 and be mechanically reinforced. In particular and as will be described herein, in some embodiments, the first terminal 104 and/or the second terminal 106 can be mechanically reinforced by the second housing 110, and in some embodiments, the first terminal 104 and/or the second terminal 106 can be mechanically reinforced by the terminal itself, including layers thereof.

In the embodiments illustrated in FIG. 1 and FIG. 2, the first terminal 104 can be bent so as to fold around and onto the second housing 110, which can provide mechanical reinforcement and support to the first terminal 104. As such, the first terminal 104 can be disposed on a top or a bottom of the second housing 110, parallel to, but in a different plane than the fusible element 102. Conversely, the second terminal 106 or a portion thereof can be straight so as to extend outside of the second housing 110 in a same plane as the fusible element 102. However, embodiments disclosed herein are not limited in this regard. Instead, the first terminal 104 and the second terminal 106 can be disposed in any orientation relative to the fusible element 102 and the second housing 110 as would be known and understood by one of ordinary skill in the art.

For example, both the first terminal 104 and the second terminal 106 can be bent so as to fold around and onto the second housing 110 with the first terminal 104 on the top of the second housing 110 and the second terminal 106 on the bottom of the second housing 110. Alternatively, the first terminal 104 or the second terminal 106 can be bent so as to fold around and onto the second housing 110 and be disposed on a side of the second housing, perpendicular to the fusible element 102. Alternatively, both the first terminal 104 and the second terminal 106 can be straight so as extend outside of the second housing 110 in the same plane as the fusible element 102. In any embodiment, the first terminal 104 and the second terminal 106 can be orientated to fit all electrical and physical requirements of the environment in which the fuse module 100 is located while being mechanically reinforced as disclosed herein.

As seen in FIG. 1, FIG. 2, FIG. 3A, FIG. 4A, and FIG. 4B, in particular, the first terminal 104 can receive a bolt 112, such as an M6 or M8 clinched bolt, in an aperture 132 of the first terminal 104 for electrically connecting the first terminal 104 to a source of electrical power or an electrical load directly or indirectly, for example, via a busbar, a cable, or the like. Similarly, although not illustrated in FIG. 1 and FIG. 2, it is to be understood that an aperture 134a of the second terminal 106 can also receive a bolt or other mechanical fastener for electrically connecting the second terminal 106 to the source of electrical power or the electrical load directly or indirectly, for example, via a busbar, a cable, or the like. Notwithstanding the various configurations of electrical connections of the first and second terminals 104, 106, it is to be understood that when the first terminal 104 is electrically connected to the source of electrical power, the second terminal 106 can be connected to the electrical load. However, when the first terminal 104 is electrically connected to the electrical load, the second terminal 106 can be electrically connected to the source of electrical power.

In some embodiments, the first housing 108 can include a top portion 114 and a bottom portion 116 that can be mechanically fit together. For example, in some embodiments, the top portion 114 can be ultrasonic welded, snap fit, heat staked, or press fit to the bottom portion 116. In some embodiments, the first housing 108 can be symmetrical, and in some embodiments, the first housing 108 can be asymmetrical.

In some embodiments, the first housing 108 can include an inner volume 118, and the fusible element 102 can be disposed within the inner volume 118. For example, the top portion 114 and the bottom portion 116 can form the inner volume 118 when mechanically fit together.

In some embodiments, the first housing 108 can include one or more venting channels 120. Although two of the venting channels 120 are illustrated on a top of the top portion 114 of the first housing 108 in FIG. 1 and FIG. 2, it is to be understood that embodiments disclosed herein are not limited in this regard. Instead, one, two, or any number of a plurality of the venting channels 120 can be formed and located anywhere on the first housing 108 as would be desired for the application in which the fuse module is used.

As seen in FIG. 3A, FIG. 3B, and FIG. 4A, in particular, in some embodiments, an exterior of the second housing 110 can include one or more side features 302, 304 for securing the second housing 110 to a fuse box. For example, the second housing 110 can include dove tails, wedges, ribs, or the like on the exterior thereof.

Some embodiments of the second terminal 106 can be double layered to provide mechanical reinforcement and support to the second terminal 106 and increased flexibility in a design of the fuse module 100, for example, in adapting to different applications and environments. Different double layered designs for the second terminal 106 are contemplated.

For example, as best seen in FIG. 1, FIG. 2, FIG. 3A, and FIG. 3B, in some embodiments, the second terminal 106 can bend 180° to overlap on itself and create a first layer 122a and a second layer 124a of the second terminal 106. In these embodiments, the first and second layers 122a, 124a can include holes 126 for receiving a mechanical fastener to lock the first and second layers 122a, 124a together. In some embodiments, the second housing 110 can be overmolded over the holes 126 and the mechanical fastener.

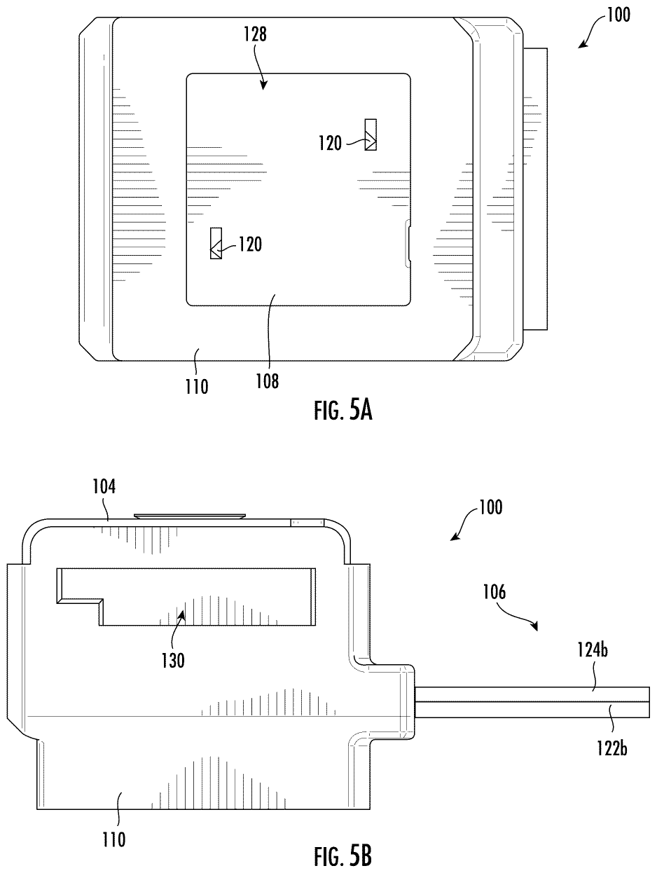

However, as best seen in FIG. 4A, FIG. 4B, FIG. 4C, and FIG. 5A, in some embodiments, the second terminal 106 can include a first layer 122b, 122c contiguous with the fusible element 102 and a second layer 124b, 124c attached to the first layer 122b, 122c. For example, in some embodiments, the second layer 124b, 124c can be attached to the first layer 122b, 122c via clinching, laser welding, adhesive bonding, soldering, or the like. In this regard, FIG. 4C illustrates a mechanical fastener 404 clinching the first layer 122b and the second layer 124b of the second terminal 106 together. However, it is to be understood that embodiments disclosed herein are not limited in this regard. Instead, the first layer 122b, 122c and the second layer 124b, 124c can be connected to one another in any manner as would be known and understood by one of ordinary skill in the art.

As best seen in FIG. 4C, in some embodiments, the second housing 110 can be overmolded over at least part of a connection between the first layer 122b and the second layer 124a of the second terminal 106, including, for example, the mechanical fastener 404. As such, the connection between the first layer 122b, 122c and the second layer 124b, 124c of the second terminal 106 can be integrated within the second housing 110.

A shape and an orientation of the second layer 124b, 124c of the second terminal 106 can be flexible and vary based on the application in which the fuse module is deployed. In this regard, the second terminal 106 can be customized. For example, as seen in FIG. 4A, the second layer 124b of the second terminal 106 can include one 90° bend in a portion thereof that extends outside of the second housing 110 and past the first layer 122b of the second terminal 106. Alternatively and as seen in FIG. 4B, the second layer 124c of the second terminal 106 can include two 90° bends in a portion thereof that extends outside of the second housing 110 and past the first layer 122c of the second terminal 106. However, it is to be understood that embodiments disclosed herein are not limited in this regard. Instead, the second layer 124b, 124c of the second terminal 106 can include one or more bends at any degree as would be known and understood by one of ordinary skill in the art.

In some embodiments, the second terminal 106 can also be customized in terms of material composition. For example, the second terminal 106 can include copper, brass, bronze, or any other material that would be desired for the application in which the fuse module is used.

Although the fuse module 100 is shown and described herein with the second terminal 106 being double layered, embodiments disclosed herein are not so limited and can include the second terminal 106 having a single layer. For example, in some embodiments, the fuse module 100 can include the fusible element 102 disposed between the first terminal 104 and the second terminal 106, the first housing 108 surrounding the fusible element 102, and the second housing 110 overmolded over the first housing 108 with both of the first terminal 104 and the second terminal 106 extending outside of the first housing 108 and the second housing 110. In these embodiments, the single layer of the second terminal 106 can provide sufficient mechanical reinforcement and support for the application in which the fuse module 100 is used.

As explained above, the second housing 110 can be overmolded over the first housing 108. During an overmolding process to form the second housing 110, one or more mold inserts can hold the first housing 108, and in some embodiments, the mold inserts can prevent the first housing 108 from collapsing during the overmolding process. Furthermore, in some embodiments, the mold inserts can partially or fully cover the venting channels 120 to block melted plastic from entering the first housing 108 during the overmolding process.

During the overmolding process, a first of the mold inserts can hold the first housing 108 on a top or a bottom thereof, and a second of the mold inserts can hold the first housing 108 on a side thereof. Accordingly and as best seen in FIG. 1 and FIG. 5A, the second housing 110 can include a first opening 128 on the top or the bottom thereof formed by the first of the mold inserts holding the first housing 108 during the overmolding of the second housing 110. Similarly and as best seen in FIG. 1, FIG. 4A, FIG. 4B, and FIG. 5B, the second housing 110 can include a second opening 130 on the side thereof formed by the second of the mold inserts holding the first housing 108 during the overmolding of the second housing 110. As best seen in FIG. 4A and FIG. 4B, a portion of the first housing 108 that is held by the mold inserts during the overmolding process can remain exposed, for example, via the second opening 130 even after the overmolding process is complete.

Although the fuse module 100 is shown and described herein with two openings 128, 130 in the second housing 110, embodiments disclosed herein are not so limited and can include any number of openings formed by any number of mold inserts during the overmolding process as would be known and understood by one of ordinary skill in the art. For example, in some embodiments, a single mold insert can hold the first housing 108 during the overmolding process, thereby forming a single opening in the second housing 110. Alternatively, any number of a plurality of the mold inserts can hold the first housing 108 during the overmolding process, thereby forming a corresponding number of the openings in the second housing 110.

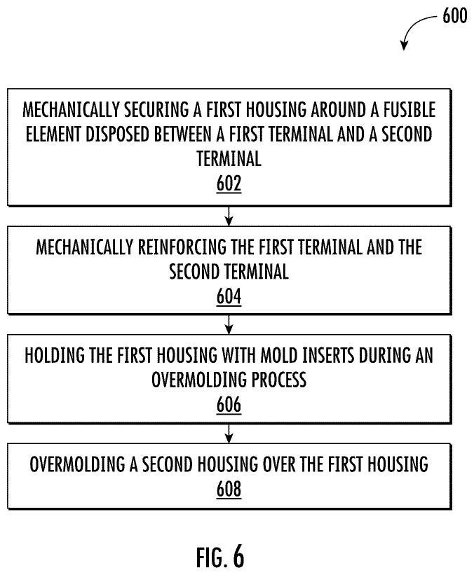

FIG. 6 is a flow chart illustrating a method 600 of manufacturing a fuse module in accordance with disclosed embodiments. It is to be understood that the method 600 can be used to manufacture the fuse module 100 and/or other fuse modules that come within the spirit and scope of disclosed embodiments.

As seen, the method 600 can include mechanically securing a first housing around a fusible element disposed between a first terminal and a second terminal as in 602. For example, in some embodiments, a top portion of the first housing can be ultrasonic welded, snap fit, heat staked, or press fit to a bottom portion of the first housing, and in some embodiments, the first terminal and the second terminal can extend outside of the first housing.

The method 600 can also include mechanically reinforcing the first terminal and the second terminal as in 604. For example, the first terminal can be bent so as to fold around and onto the second housing. Additionally or alternatively, the second terminal can be bent 180° to overlap on itself and create first and second layers of the second terminal, or a second layer of the second terminal can be attached to a first layer of the second terminal that is contiguous with the fusible element. In any embodiment, after mechanical reinforcement of the first terminal and the second terminal, the method 600 can include holding the first housing with one or more mold inserts during an overmolding process as in 606.

Finally, the method 600 can include overmolding a second housing over the first housing as in 608. For example, in some embodiments, the second housing can be overmolded with one or more side features for securing the second housing to a fuse box. In some embodiments, the first terminal and the second terminal can extend outside of the second housing.

When the second terminal is bent 180° to overlap on itself and create the first and second layers of the second terminal, the second housing can be overmolded over holes disposed in the first and second layers and a mechanical fastener disposed therein. However, when the second layer of the second terminal is attached to the first layer of the second terminal to lock the first and second layers together, the second housing can be overmolded over at least part of a connection between the first layer and the second layer.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the spirit and scope of the present disclosure, as defined in the appended claims. Accordingly, it is intended that the present disclosure not be limited to the described embodiments, but that it has the full scope defined by the language of the following claims and equivalents thereof.

What is claimed is:

1. A fuse module comprising:
a fusible element disposed between a first terminal and a second terminal;
a first housing surrounding the fusible element; and
a second housing overmolded over the first housing,
wherein the first terminal extends outside of the first housing and the second housing and is mechanically reinforced, and
wherein the second terminal extends outside of the first housing and the second housing and is mechanically reinforced.

2. The fuse module of claim 1 wherein the first housing includes a top portion and a bottom portion that are mechanically fit together.

3. The fuse module of claim 1 wherein the first housing includes an inner volume, and wherein the fusible element is disposed within the inner volume.

4. The fuse module of claim 1 wherein the first housing includes at least one venting channel.

5. The fuse module of claim 1 wherein an exterior of the second housing includes one or more side features for securing the second housing to a fuse box.

6. The fuse module of claim 1 wherein the second terminal bends 180° to overlap on itself and create first and second layers of the second terminal.

7. The fuse module of claim 6 wherein the first and second layers include holes for receiving a mechanical fastener to lock the first and second layers together.

8. The fuse module of claim 7 wherein the second housing is overmolded over the holes and the mechanical fastener.

9. The fuse module of claim 1 wherein the second terminal includes a first layer contiguous with the fusible element and a second layer attached to the first layer.

10. The fuse module of claim 9 wherein the second housing is overmolded over at least part of a connection between the first layer and the second layer.

11. The fuse module of claim 1 wherein the second housing includes one or more openings formed by one or more mold inserts that hold the first housing during an overmolding process to form the second housing, and wherein a portion of the first housing held by the one or more mold inserts during the overmolding process remains exposed after the overmolding process.

12. A method of manufacturing a fuse module, the method comprising:
mechanically securing a first housing around a fusible element disposed between a first terminal and a second terminal; and
overmolding a second housing over the first housing,
wherein the first terminal extends outside of the first housing and the second housing and is mechanically reinforced, and
wherein the second terminal extends outside of the first housing and the second housing and is mechanically reinforced.

13. The method of claim 12 further comprising:
ultrasonic welding, snap fitting, heat staking, or press fitting a top portion and a bottom portion of the first housing together.

14. The method of claim 12 wherein the first housing includes an inner volume and at least one venting channel, and wherein the fusible element is disposed within the inner volume.

15. The method of claim 12 further comprising:
overmolding the second housing with one or more side features for securing the second housing to a fuse box.

16. The method of claim 12 further comprising:
bending the second terminal 180° to overlap on itself and create first and second layers of the second terminal.

17. The method of claim 16 further comprising:
overmolding the second housing over holes disposed in the first and second layers and a mechanical fastener disposed therein to lock the first and second layers together.

18. The method of claim 12 further comprising:
attaching a second layer of the second terminal to a first layer of the second terminal that is contiguous with the fusible element; and
overmolding the second housing over at least part of a connection between the first layer and the second layer.

19. The method of claim 12 further comprising:
holding the first housing with one or more mold inserts during an overmolding process to form the second housing.

20. The method of claim 19 wherein the second housing includes one or more openings formed by the one or more mold inserts, and wherein a portion of the first housing held by the one or more mold inserts during the overmolding process remains exposed after the overmolding process.
